(19) United States
(12) Patent Application Publication
(10) Pub. No.: US 2009/0188566 A1
(43) Pub. Date: Jul. 30, 2009

(54) PNEUMATIC PRESSURE REGULATOR

(75) Inventor: Herbert Moller, Bad Oeynhausen (DE)

Correspondence Address: BUCHANAN, INGERSOLL & ROONEY PC, POST OFFICE BOX 1404, ALEXANDRIA, VA, 22313-1404, US

(73) Assignee: ABB AG, Mannheim (DE)

(21) Appl. No.: 12/360,963

(22) Filed: Jan. 28, 2009

(30) Foreign Application Priority Data
Jan. 28, 2008 (DE) 102008006407.6-52

(51) Int. Cl. F16K 31/12

(52) U.S. Cl. 137/14; 137/505

(57) ABSTRACT

The disclosure relates to a pneumatic pressure regulator for pressure adjustment of a regulating pressure in a pressure chamber with a regulator membrane which is held in force equilibrium by a regulator spring and the regulating pressure, wherein the regulator membrane is coupled with a control valve in such a way that the control valve opens or closes in dependence upon the actual regulating pressure. For increasing the stability and the constancy of the regulating pressure it is proposed to form the control valve by a dimensionally stable ball which is seated in a loaded manner by means of a spring in a conical bore which tapers in the direction of the regulator membrane and is in a housing wall which lies opposite the regulator membrane with regard to the pressure chamber, the regulator membrane having a reinforcement in the contact region with the ball, and the ball following the movement of the regulator membrane in its normal direction.

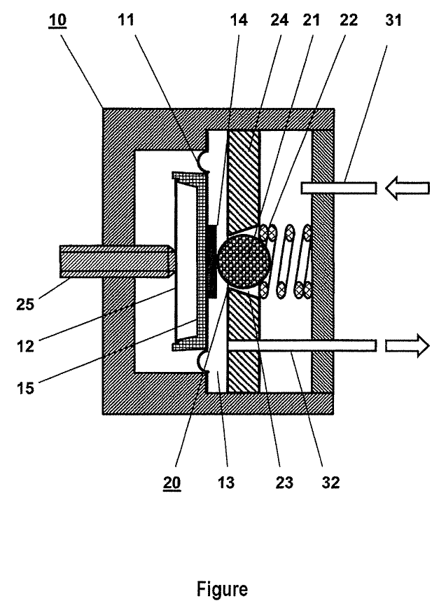

### RELATED APPLICATION

This application claims priority under 35 U.S.C. §119 to German Patent Application No. DE 10 2008 006 407.6-52 filed in Germany on Jan. 28, 2008, the entire content of which is hereby incorporated by reference in its entirety.

### TECHNICAL FIELD

A pneumatic pressure regulator is disclosed for pressure adjustment of a regulating pressure with a regulator membrane which is held in force equilibrium by a regulator spring and the regulating pressure.

### BACKGROUND INFORMATION

Such pneumatic pressure regulators are generally known and are 15 used for setting a constant regulating pressure independently of pressure fluctuations of a supplied pressurized medium.

A pneumatic pressure regulator is known from WO 05088417 A1, the passage of which can be automatically altered depending upon pressure, with an operating membrane which is acted upon by a reference pressure, by the gas pressure and also by a regulator spring, as a result of which the operating membrane is adjusted when the differential pressure changes, and the membrane itself, or a shut-off component which is operated by it, alters the passage through an outflow cross section, and wherein a structure which is adjacent to the outflow cross section on the membrane side forms a stop for the operating membrane, or for the shut-off component, in their closed position. In this case, provision is made for at least one pre-stop to be arranged in the pressure regulator so that with movement of the operating membrane in the closing direction the operating membrane, or the shut-off component, first comes into contact with the pre-stop and so that with further movement of the operating membrane in the closing direction, the operating membrane, or the shut-off component, by elastically flexible deformation, or by further elastically flexible deformation, then further reduces the passage and in an end position also comes into contact with the stop.

A pressure regulator for pneumatic and hydraulic pressurized media is known from DE 3305092 C2, which comprises a housing with primary port, secondary port and relief port, and an on-off valve which is arranged in the housing and comprises a valve spool, which supports a valve plate, and its valve seat, which is fixed in the housing, between primary port and secondary port. The on-off valve opens with the primary pressure. The valve spool projects through the valve seat. The valve plate of the relief valve can be acted upon by the force of a control solenoid. There is a control port, which is provided with a control spool, for the feedback of a control variable. The control spool is connected in a fixed manner to the valve plate of the relief valve via a pushpin. The pushpin extends through the hollow valve spool of the on-off valve and also through a bore in the valve plate of the on-off valve. The end of the hollow valve spool which faces away from the on-off valve forms a valve seat for the valve plate of the relief valve.

A pneumatic pressure regulator is known from DE 20 2004 003 860 U1, which is arranged in the run of a gas line, the passage of which valve can be automatically altered by means of the pressure regulator in dependence upon the differential pressure between one or more gas pressures which are applied at at least one inlet of the pressure regulator. In this case, an operating membrane is provided in the pressure regulator, which on one side is acted upon by a reference pressure, and on the other side by the gas pressure, or gas pressures, and also by a regulator spring.

By altering the differential pressure between the regions which are adjacent to the operating membrane, the operating membrane is adjusted, and the operating membrane itself, or a shut-off component which is operated by the operating membrane, increases or reduces the passage through an outflow cross section of the pressure regulator. In this case, a structure of the pressure regulator which is adjacent to the outflow cross section on the membrane side forms a stop for the operating membrane, or for the shut-off component which is operated by the operating membrane, in their closing position. At least one pre-stop is arranged in the pressure regulator so that with movement of the operating membrane in the closing direction, the operating membrane, or the shut-off component which is operated by the operating membrane, first makes contact with the pre-stop. With further movement of the operating membrane in the closing direction, the operating membrane, or the shut-off component which is operated by the operating membrane, then further reduces the passage by further elastically flexible deformation, and in an end position also makes contact with the stop.

The elastically flexible deformation of the shut-off component in the long term follows a permanent plastic deformation. This disadvantageously influences the constancy of the regulating pressure since small changes to the pretensioning of the regulator spring already lead to impermissible deviations of the set regulating pressure. In a particularly disadvantageous way, these impermissible deviations at first remain hidden and stay undetected as a cause of apparent malfunctions of associated devices.

### SUMMARY

The disclosure is therefore based on the object of increasing the stability and the constancy of the regulating pressure for a known pneumatic pressure regulator.

A pneumatic pressure regulator is disclosed for pressure adjustment of a regulating pressure in a pressure chamber with a regulator membrane which is held in force equilibrium by a regulator spring and the regulating pressure, wherein the regulator membrane is coupled with a control valve in such a way that the control valve opens or closes in dependence upon the actual regulating pressure, wherein the control valve is formed by a dimensionally stable ball, which is seated in a loaded manner by means of a spring in a conical bore which tapers in the direction of the regulator membrane and is in a housing wall which lies opposite the regulator membrane with regard to the pressure chamber, and which ball follows the movement of the regulator membrane in its normal direction.

In another aspect, a method for pressure adjustment of a regulating pressure is disclosed. Such a method relates to a pressure chamber with a regulator membrane which is held in force equilibrium by a regulator spring and the regulating pressure. Such a method comprises coupling the regulator membrane with a control valve in such a way that the control valve opens or closes in dependence upon the actual regulating pressure; and seating a dimensionally stable ball in a loaded manner based on a spring in a conical bore which tapers in the direction of the regulator membrane and is in a housing wall which lies opposite the regulator membrane with regard to the pressure chamber, and which ball follows the movement of the regulator membrane in its normal direction, wherein the control valve is based on the dimensionally stable ball.

### BRIEF DESCRIPTION OF THE DRAWING

Further details and advantages of the disclosure are subsequently explained in more detail based on an exemplary embodiment. In the single FIGURE, an exemplary pneumatic pressure regulator is shown in sectioned view.

### DETAILED DESCRIPTION

The disclosure is based on a pneumatic pressure regulator for pressure adjustment of a regulating pressure in a pressure chamber with a regulator membrane which is held in force equilibrium by a regulator spring and the regulating pressure. The regulator membrane is coupled with a control valve in such a way that the control valve opens or closes in dependence upon the actual regulating pressure.

According to the disclosure, an exemplary embodiment of a control valve is formed by a dimensionally stable ball, which is seated in a spring-loaded manner in a conical bore which tapers in the direction of the regulator membrane and is in a dimensionally stable housing wall which lies opposite the regular membrane with regard to the pressure chamber, and which ball follows the movement of the regulator membrane in its normal direction.

With falling regulating pressure in the pressure chamber, the regulator spring presses the regulator membrane against the ball and pushes this from its seat. In doing so, the control valve is opened and the feed of unregulated pressurized medium is released. Upon achieving the regulating pressure, the regulator membrane yields to the regulator spring. The force of the spring presses the ball into its seat and the control valve is closed.

The dimensionally stable shut-off means of the control valve advantageously have a high stability which brings about a high constancy of the regulating pressure.

According to another exemplary embodiment of the disclosure, the diameter of the ball to the conicity of the bore is in a proportion to the extent that a ball segment of the ball penetrates into the pressure chamber in the direction of the regulator membrane. In doing so, the ball makes contact in a point-like manner with the regulator membrane in the pressure chamber.

The construction of the direct interaction between the regulator membrane and the ball as an operating element of the control valve is advantageously very simple and maintenance-free due to dispensing with multipart force transmission elements.

According to yet another exemplary embodiment of the disclosure, the regulator membrane is plastically reinforced in the region of the control valve. As a result, in the case of low regulating pressures and correspondingly soft regulator membranes, damage or deformation of the surface of the regulator membrane is avoided.

In the single FIGURE, an exemplary pneumatic pressure regulator 10 is shown in sectioned view. The pressure regulator 10 has a pressure chamber 13 which is enclosed by means of a regulator diaphragm 11 and a housing wall 24 which lies opposite this.

In the housing wall 24 a control valve 20 is arranged, which is formed by means of a dimensionally stable ball 21 which, loaded by means of a spring 22, is seated in a conical bore 23 which tapers in the direction of the regulator membrane 11. The unregulated pressurized medium 31 is fed to the side of the ball 21 which faces the spring 22.

The regulator membrane 11 is supported with in a frictionally contacting manner on a pressure plate 15 which is connected to an axially symmetrical regulator spring 12. The regulator spring 12 is supported at its gravity point upon an adjusting screw 25. In a first embodiment of the disclosure, the regulator spring 12 is constructed as a disc spring. In an exemplary embodiment, the regulator spring 12 is designed as a spring star for low regulating pressures 32. In this case, provision can be made for the pressure plate 15 to be connected in a frictionally contacting manner to the regulator membrane 11.

The diameter of the ball 21 to the conicity of the bore 23 is in a proportion to the extent that a ball segment of the ball 21 penetrates into the pressure chamber 13 in the direction of the regulator membrane 11. In this case, the ball 21 lies in a frictionally contacting manner on the regulator membrane 11 and is operated directly by means of the regulator membrane 11 in dependence upon the pressure in the pressure chamber 13.

The regulator membrane 11 is plastically reinforced in the region of the control valve 20. In a first embodiment, provision can be made for the regulator membrane 11 to have a greater material thickness in the region of the control valve 20 than on its edge. In an alternative embodiment, the regulator membrane 11 is reinforced in the region of the control valve 20 by means of a fixed plate. In a special development of the disclosure this plate is formed by a metal plate 14. This embodiment is particularly suitable for soft regulator membranes 11 for adjusting low regulating pressures 32.

The metal plate 14 can be arranged on the side of the regulator membrane 11 which faces the pressure chamber 13. In this case, the ball 21 of the control valve 20 rests upon the metal plate 14 of the regulator membrane 11. As a result, damage to the regulator membrane 11 is avoided and the constancy of the regulating pressure 32 achieved.

With falling regulating pressure in the pressure chamber 13, the regulator spring 12 presses the regulator membrane 11 against the ball 21 and pushes this from its seat. In doing so, the control valve 20 is opened and the feed of unregulated pressurized medium 31 is released. Upon achieving the regulating pressure 32, the regulator membrane 11 yields to the regulator spring 12. The force of the spring 22 presses the ball 21 into its seat and the control valve 20 is closed. The correct regulating pressure 32 is set by the adjusting screw 25.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

List of Designations
10 Pressure regulator
11 Regulator membrane
12 Regulator spring
13 Pressure chamber
14 Reinforcement
15 Pressure plate
20 Control valve
21 Ball
22 Spring
23 Bore
24 Housing wall
25 Adjusting screw
31 Unregulated pressurized medium
32 Regulating pressure

What is claimed is:

1. A pneumatic pressure regulator for pressure adjustment of a regulating pressure in a pressure chamber with a regulator membrane which is held in force equilibrium by a regulator spring and the regulating pressure, wherein the regulator membrane is coupled with a control valve in such a way that the control valve opens or closes in dependence upon the actual regulating pressure, wherein
the control valve is formed by a dimensionally stable ball, which is seated in a loaded manner by means of a spring in a conical bore which tapers in the direction of the regulator membrane and is in a housing wall which lies opposite the regulator membrane with regard to the pressure chamber, and which ball follows the movement of the regulator membrane in its normal direction.

2. The pressure regulator as claimed in claim 1, wherein
the diameter of the ball to the conicity of the bore is in a proportion to the extent that a ball segment of the ball penetrates into the pressure chamber in the direction of the regulator membrane.

3. The pressure regulator as claimed in claim 1, wherein
the regulator membrane is plastically reinforced in the region of the control valve.

4. The pressure regulator as claimed in claim 3, wherein
the regulator membrane is reinforced by means of a metal plate in the region of the control valve.

5. The pressure regulator as claimed in claim 4, wherein
the metal plate is arranged on the side of the regulator membrane which faces the pressure chamber.

6. The pressure regulator as claimed in claim 1, wherein
the ball is connected to the regulator membrane in a frictionally contacting manner.

7. The pressure regulator as claimed in claim 1, wherein
the regulator spring is supported upon an adjusting screw.

8. The pressure regulator as claimed in claim 1, wherein
the regulator spring is indirectly connected to the regulator membrane via a pressure plate in a frictionally contacting manner.

9. The pressure regulator as claimed in claim 2, wherein
the regulator membrane is plastically reinforced in the region of the control valve.

10. The pressure regulator as claimed in claim 5, wherein
the ball is connected to the regulator membrane in a frictionally contacting manner.

11. The pressure regulator as claimed in claim 6, wherein
the regulator spring is supported upon an adjusting screw.

12. The pressure regulator as claimed in claim 7, wherein
the regulator spring is indirectly connected to the regulator membrane via a pressure plate in a frictionally contacting manner.

13. A method for pressure adjustment of a regulating pressure in a pressure chamber with a regulator membrane which is held in force equilibrium by a regulator spring and the regulating pressure, the method comprising:
coupling the regulator membrane with a control valve in such a way that the control valve opens or closes in dependence upon the actual regulating pressure; and
seating a dimensionally stable ball in a loaded manner based on a spring in a conical bore which tapers in the direction of the regulator membrane and is in a housing wall which lies opposite the regulator membrane with regard to the pressure chamber, and which ball follows the movement of the regulator membrane in its normal direction, wherein the control valve is based on the dimensionally stable ball.
